(19) United States
(12) Patent Application Publication
(10) Pub. No.: US 2015/0355135 A1
(43) Pub. Date: Dec. 10, 2015

(54) ELECTROCHEMICAL DETECTION SYSTEM AIR WASHING

(71) Applicant: VANTIX HOLDINGS LIMITED, Jersey (GB)

(72) Inventor: Andy Gover, Cambridgeshire (GB)

(21) Appl. No.: 14/759,648

(22) PCT Filed: Jan. 9, 2014
(86) PCT No.: PCT/GB2014/050057

§ 371 Date: Jul. 7, 2015

Related U.S. Application Data
(60) Provisional application No. 61/750,956, filed on Jan. 10, 2013.

(51) Int. Cl. G01N 27/38

(52) U.S. Cl. CPC G01N 27/38

(57) ABSTRACT

Some embodiments include a platform for performing a plurality of assays. The platform may include a support structure that further includes a plurality of channels in selective fluid flow communication with at least one flow cell. The platform may also include a plurality of sensors operatively associated with the flow cell so that the sensors are configured to detect a reaction during the performance of the plurality of assays. The channels are in selective fluid flow communication with an air source so that these channels can guide a volume of air into the flow cell during the performance of the plurality of assays to wash the sensors between successive applications of solutions required to develop the assay complex which is subsequently detected.

### CROSS-REFERENCE

The present disclosure claims priority to U.S. Provisional Application Ser. No. 61/750,956 filed Jan. 10, 2013, and entitled “Electrochemical Detection System,” which is incorporated herein by reference in its entirety.

### FIELD

The use of air as a washing step instead of a liquid can be applied to any formats of flow cell or detection method where a biosensor is incorporated. The air wash may be used to clear the surface of the biosensor as well as to separate the sample from any subsequent liquids, such as a targeted label or a measuring solution. The present disclosure generally relates to an electrochemical detection system for conducting electrochemical analysis, and more particularly to an electrochemical detection system that includes a cartridge or other platform that may be adapted to engage a reader to perform multiple assays using one or more particular fluids, such as air, for washing portions of the cartridge during multiple assays.

### BACKGROUND

Biosensoring is a branch of detection science that measures chemical or biological entities in liquid samples. To perform a detection event, the analyte is captured from the sample by an immobilized specific binding receptor, such as an antibody, aptamer, or nucleic acid. After the capture of the analyte, a labeling component is added to the complex or the biosensor, which provides a quantitative measure of the presence of the analyte. Finally a measuring medium, such as a liquid, light, sound, is applied to activate the label, which is subsequently detected by a variety of means, for example electrochemically, optically, acoustically, or magnetically. This detection may be performed in one or more steps and the previous liquid may be effectively removed from the collection and detection area before the next active solution is used. This method is normally performed using a washing step using a neutral liquid or buffer.

Electrochemistry is a branch of chemistry that studies chemical reactions occurring in a solution at the interface between an electrode and an electrolyte. The reaction may involve charge transfer between the electrode and the electrolyte. For example, the electrode may comprise a metal or a semiconductor.

Under some circumstances, the chemical reactions discussed above may be driven by applying either an externally derived voltage or a voltage created by a chemical reaction. Under these circumstances, chemical reactions are known as electrochemical reactions. Moreover, some chemical reactions where electrons are transferred between one or more molecules are known as oxidation/reduction reactions or redox reactions. Generally, electrochemistry relates to situations where oxidation and reduction reactions are separated in space or time and are connected by an external electric circuit that may control or quantify the reaction.

Some electrochemical analyses may be undertaken in a disposable cartridge that includes a reagent for inducing electrochemical reactions controlled, monitored, detected, or quantified by one or more sensors. Some conventional cartridges may be configured to operatively engage a reader device that initiates a protocol, such as via mechanical actuation of the cartridge. Furthermore, the reader device may receive data signals to produce test results of the reaction occurring within the cartridge.

At least some conventional cartridges employ a liquid wash fluid for washing portions of the cartridge during the electrochemical reactions. By way of example, some conventional cartridges may use at least three fluid-processing steps with one, two, or more washing steps interposed between the processing steps to ensure precision and sensitivity of the electrochemical reactions. The liquid wash fluid, however, is generally stored within the cartridge, for example in a cartridge-based reservoir, which may add costs to the cartridge and complexity to the cartridge design.

### SUMMARY

In one embodiment, the electrochemical system includes a platform for performing a plurality of assays, which may include a support structure. The support structure may include a plurality of channels in selective fluid flow communication with at least one flow cell. Moreover, the platform may also include a plurality of sensors operatively associated with the flow cell so that the sensors are configured to detect a reaction during the performance of the plurality of assays. In addition, at least some pluralities of channels are in selective fluid flow communication with an air source. Furthermore, the channels in selective fluid flow communication with the air source may be configured to guide a volume of air from the air source to the flow cell during the performance of the assays. For example, the volume of air flowing through the flow cells may be used to wash the sensors and the flow cells during the performance of the plurality of assays. In addition, the flow of the volume of air over the sensors may exhibit a generally laminar flow.

In one aspect, the electrochemical system includes a cartridge for performing a plurality of assays may include a container pack. The container pack may include a plurality of containers for storing at least one fluid reagent and at least a portion of the container can include a volume of air. The cartridge may also include a fluidic pathway engaged to the container pack. The fluidic pathway may include a plurality of channels in selective fluid flow communication with a plurality of flow cells through an arrangement of valves such that each plurality of flow cells is isolated from the other flow cells during the performance of a plurality of assay protocols. Moreover, the platform may also include a plurality of sensors operatively associated with the plurality of flow cells so that the sensors are configured to detect a reaction during the performance of the plurality of assays. In addition, at least some pluralities of channels are in selective fluid flow communication with the containers that include the volume of air for delivering at least a portion of the air to the flow cells during the performance of the plurality of assays. For example, the volume of air flowing through the flow cells may be used to wash the sensors and flow cells during the performance of the plurality of assays. In one particular aspect, air is the only substance used to wash the plurality of sensors and flow cells to the exclusion of all other fluids. In one aspect, the plurality of flow cells may be washed multiple times with multiple volumes of air during the performance of the plurality of assay protocols. In another embodiment, the air may come from an external source or from the atmosphere, and may be injected using valves and pumps.

Yet another aspect of the detection system may include a method for operating a platform for performing a plurality of assay protocols. Some aspects of the method may include providing a support structure that may include a plurality of channels in selective fluid flow communication with a plurality of flow cells. In one instance, at least a portion of the plurality of channels may fluidly couple the plurality of flow cells with a source of a volume of air. The method may also include circulating a fluid through at least some of the plurality of channels so that at least a portion of the fluid passes into the plurality of flow cells. In addition, the method may provide circulating at least a portion of the volume of air through the plurality of channels and into the plurality of flow cells to displace at least a portion of the fluid within the plurality of flow cells. For example, in one aspect, the source of the volume of air may be a reservoir.

In one aspect, the method may also include engaging a container pack to the support structure. In particular, the container pack may include a plurality of containers in selective fluid flow communication with the plurality of channels. For example, at least some of the containers may function as the source of the volume of air.

In yet another aspect, the electrochemical detection system may include a platform for performing a plurality of assays, which includes a support structure. In particular, the support structure may include a plurality of channels in selective fluid flow communication with a plurality of flow cells and at least one aperture defined through a portion of the support structure. The platform may also include a plurality of sensors that may be operatively associated with the plurality of flow cells such that the plurality of sensors may be configured to detect a reaction during the performance of the plurality of assays. In addition, the platform may also include an actuating device, such as a solenoid, that may be at least partially supported by the support structure and may be configured to enable selective fluid flow communication between the aperture defined through the support structure and at least one of the plurality of channels. Moreover, the one or more channels in selective fluid flow communication with the aperture may be configured to guide a volume of air through the aperture and into the plurality of flow cells when the actuating device is activated. As a result, in one aspect, the volume of air may be used to wash the plurality of sensors during the performance of the plurality of assays. For example, the volume of air flowing over the sensors may exhibit a generally laminar flow, which may lead to improved washing of the sensors and the flow cells.

One embodiment may also include a method for assembling a platform for performing a plurality of assays. For example, the method may include providing a support structure that includes a plurality of channels that may be in selective fluid flow communication with a plurality of flow cells. The method may also include disposing a plurality of sensors within each plurality of flow cells and disposing an aperture at least partially through a portion of the support structure. In one aspect, the method may include positioning a solenoid immediately adjacent to the aperture such that when the solenoid is activated, the aperture come in fluid flow communication with at least some of the plurality of channels. As a result, a volume of air may pass through the aperture and into the plurality of channels to wash the plurality of sensors and the plurality of flow cells during the performance of the plurality of assays. For example, the volume of air may exhibit a laminar flow through the at least one flow cell to wash the sensors.

In yet another aspect, one embodiment may include a method for performing a plurality of assays. For example, the method may include providing a support structure that includes a plurality of channels that may be in selective fluid flow communication with a plurality of flow cells. The method may also include disposing a plurality of sensors within each of the plurality of flow cells and disposing an aperture at least partially through a portion of the support structure. In one aspect, the method may include positioning a solenoid immediately adjacent to the aperture such that when the solenoid is activated, the aperture comes in fluid flow communication with at least some of the plurality of channels. As a result, when the aperture is in fluid flow communication with the plurality of channels, a volume of air may pass through the aperture and into the plurality of channels to wash the plurality of sensors during the performance of the plurality of assays.

The method may further include circulating a fluid through at least some of the plurality of channels so that at least a portion of the fluid passes into the plurality of flow cells and contacts the plurality of sensors. After circulating the fluid, the method may provide activating the solenoid and then circulating at least a portion of the volume of air that passes through the aperture into the plurality of channels and through the plurality of flow cells to displace at least a portion of the fluid within the plurality of flow cells.

Additional objectives, advantages and novel features will be set forth in the description which follows or will become apparent to those skilled in the art upon examination of the drawings and detailed description which follows.

### BRIEF DESCRIPTION OF THE DRAWINGS

FIG. 1 is simplified block diagram illustrating the different components of the electrochemical detection system.

FIG. 2 is a top view of a sensor arrangement used in the cartridge for electrochemical detection.

FIG. 3 is a top view of another embodiment of the sensor arrangement used in the cartridge for electrochemical detection.

FIG. 4 is an exploded view of the sensor arrangement shown in FIG. 2.

Corresponding reference characters indicate corresponding elements among the view of the drawings. The headings used in the figures should not be interpreted to limit the scope of the claims.

### DETAILED DESCRIPTION

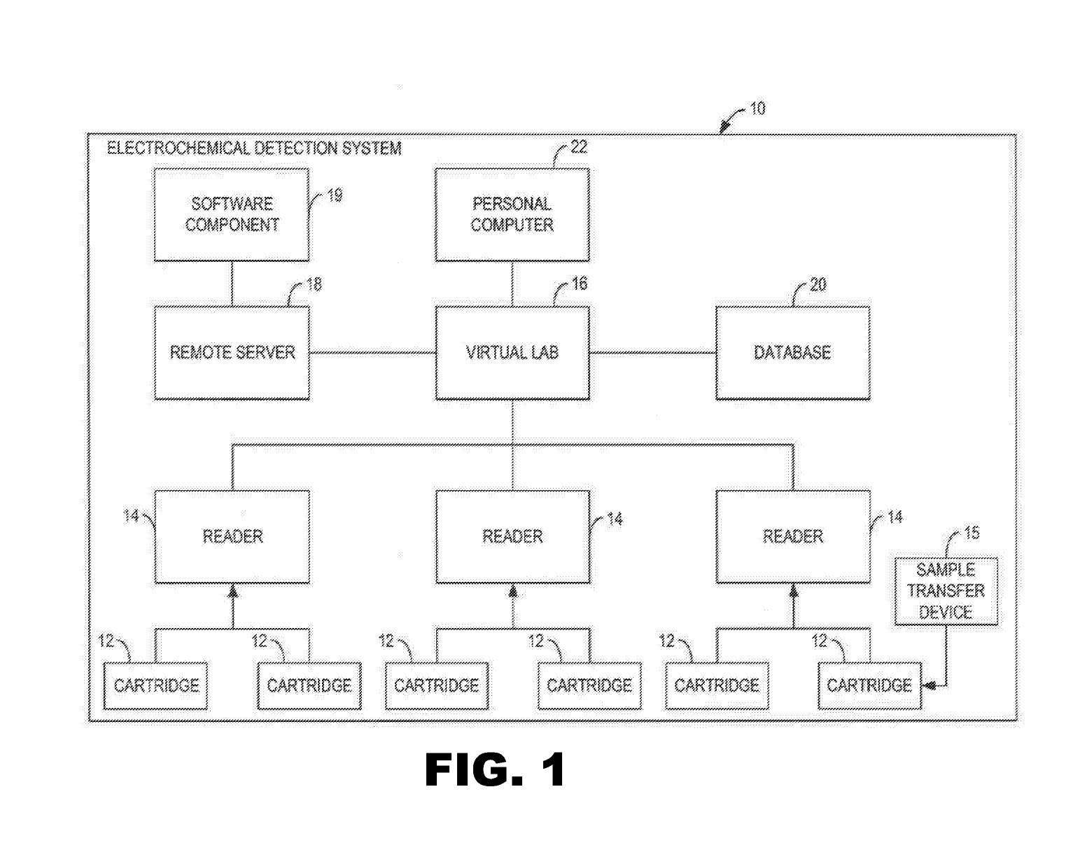

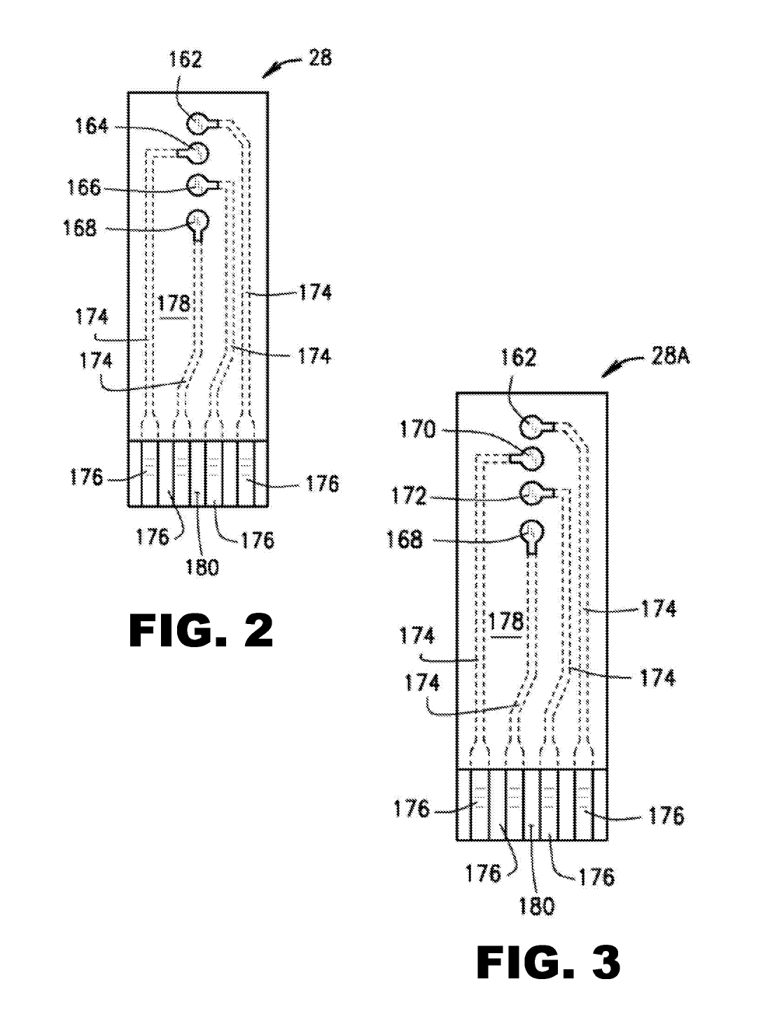

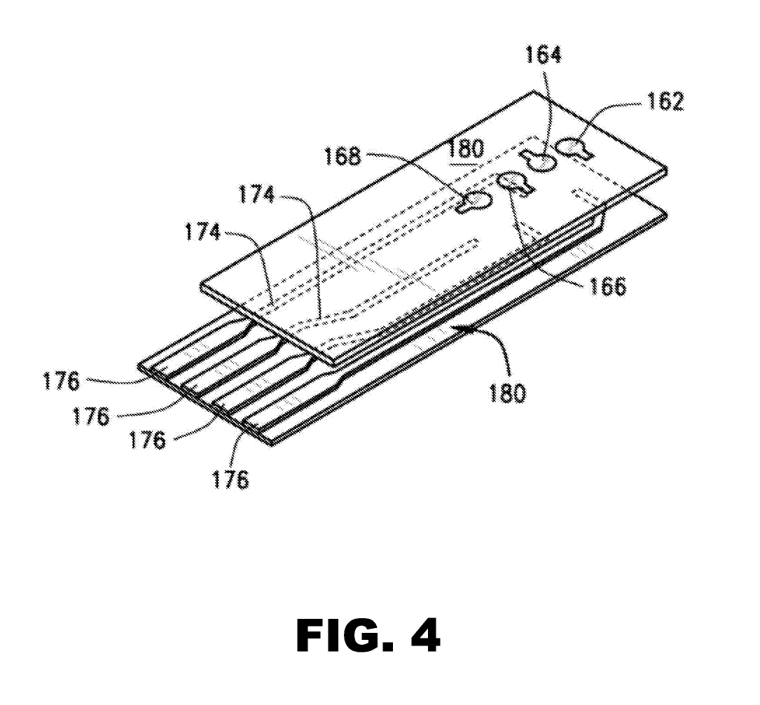

Referring to the drawings, an embodiment of the electrochemical detection system is illustrated and generally indicated as 10 in FIG. 1. The electrochemical detection system 10 provides a means for conducting a plurality of assay protocols on a single disposable cartridge 12 when operatively engaged to a reader 14. In addition, the electrochemical detection system 10 may include a plurality of readers 14 in operative communication with a virtual lab 16 for communicating data, such as test results or calibration information, between the readers 14 and a remote server 18 associated with the virtual lab 16. Moreover, in some embodiments, the electrochemical detection system 10 may be configured and arranged so that the performance of the plurality of assay protocols includes one or more washing steps to provide accurate and sensitive detection of assay results. For example, in some embodiments, fluids, such as air, may be used in the washing steps to provide for substantial or complete washing of some portions of the electrochemical detection system 10. By way of example only, in one embodiment, the only washing fluid/washing reagent used during the performance of one or more of the plurality of assays may be air, to the exclusion of other fluids. In some embodiments, a combination of air and other fluids may be used as a washing reagent.

In some embodiments, the general platform for performing receptor/binding assays may be configured and arranged to enable washing of one or more flow cells using one or more fluids. Specifically, components of the detection system 10, such as the flow cells or the sensors, may be washed at each step of the protocol to ensure acceptable levels of precision and sensitivity.

Generally, in some embodiments, the detection system 10 may employ three fluidic processing steps with at least two intermediate washing steps to ensure adequate washing between the fluidic processing steps. In particular, the fluidic processing steps, as previously mentioned, may include circulating a sample and/or a reagent (e.g., conjugate) through the plurality of channels and into the flow cells. Then, the sample or reagent may be washed from the flow cells by circulating a wash reagent (e.g., a fluid wash reagent) one or more times through the flow cells and over the plurality of sensors to remove any undesirable substances, such as excess sample or reagent. Moreover, this process may be repeated multiple times until the assays are completed.

In some embodiments, the fluid used to wash the flow cells may be a liquid. In other embodiments, the fluid may be air or a similar gas, such as nitrogen, argon, helium, or oxygen. Specifically, in some embodiments, the fluid, such as the wash agent or washing reagent, is only air, to the exclusion of other washing fluids or substances. In other words, in some embodiments, the only substance used to wash the flow cells or the sensors may be air or another gas.

In some embodiments, the support structure may include one or more air sources, including a volume of air, such as purified or substantially unpurified volumes of air or other gases, used to wash the flow cells or the sensors. For example, the air sources may be in selective fluid flow communication with one or more of the plurality of channels. As a result, when the air source is in fluid flow communication with the plurality of channels, for example during the washing steps described herein, air may flow through the plurality of channels and pass through the flow cells to wash, drive, or otherwise force any liquids within the flow cells from the flow cells, for example into one or more waste channels or chambers. In particular, the flow of the air through the flow cells and over the plurality of sensors may exhibit a substantially laminar flow. As a result of the laminar flow, the air may sufficiently wash the plurality of flow cells and the plurality of sensors, leading to the substantial or complete removal of any undesirable substances left within the flow cells, and to improved performance of the electrochemical detection system 10.

In some embodiments, the one or more air sources may be configured as one or more different structures that may guide a volume of air into one or more of the plurality of channels. Moreover, any of the following non-limiting embodiments may be used together to provide air or other gases for washing the flow cells or sensors. In addition, the following embodiments are only intended as examples of potential sources of air or other gasses; any other possible air sources may be used to provide air as a wash agent.

In one embodiment, the air source may be a reservoir. For example, the support structure may define one or more reservoirs in selective fluid flow communication with one or more of the plurality of channels, such as via one or more valves. In particular embodiments, the reservoirs may be at least partially pressurized so that when the plurality of channels are fluidly coupled to the one or more reservoirs, the pressure within the reservoirs may force the air or other gases to flow through the channels and the flow cells and over the sensors to provide a washing effect. In additional embodiments, the reservoirs may be positioned within the reader 14 so that when the general platform or cartridge 12 is placed within the reader 14, the plurality of channels may be fluidly coupled to the one or more reservoirs.

In some embodiments, the air source may be an environment surrounding the electrochemical detection system 10. For example, one or more apertures may be defined through one or more portions of the support structure to enable fluid flow communication between the environment surrounding the general platform/support structure and one or more of the plurality of channels. In one embodiment, one or more actuating devices may be positioned immediately adjacent to the one or more apertures, for example one actuating device per aperture, to control the selective fluid flow communication between the apertures and the plurality of channels. For example, at least some actuating devices may be at least partially supported by the support structure. In other embodiments, at least some actuating devices may be positioned within the reader 14 so that when the general platform/support structure is disposed within the reader 14, the actuating devices may engage the apertures. In yet other embodiments, some actuating devices may be supported by the support structure and some actuating devices may be disposed within the reader 14.

In some embodiments, the actuating device may be configured as a solenoid. In other embodiments, the actuating device may be configured as any other device that may enable selective fluid flow communication between the apertures and the plurality of channels. The solenoids may comprise generally conventional solenoid-like configurations, such as a coil circumscribing at least a portion of a plunger comprising a magnetically active material. By way of example only, the solenoids may be positioned immediately adjacent to the apertures so that when in an inactive or resting state, for example when little to no current is circulating through the coil, the plungers of the respective solenoids are engaged to an area of the support structure defining the apertures so that no significant amount of air or other gas enter the plurality of channels.

In some embodiments, upon activation, the circulation of current through the coil, the plunger may be moved from its resting position to enable air or other gasses to enter the plurality of channels, and flow through and over the flow cells and sensors, respectively. For example, the support structure and the plurality of channels may be sealed and under negative pressure so that upon opening of the apertures via withdrawal of the plunger, the air may readily flow into the support structure and the plurality of channels. Then, upon completing the washing step, the circulation of current through the coil may be substantially or completely ceased so that a biasing member may drive the plunger to the resting position to cease any substantial amount of air or other gas from entering the plurality of channels. As previously mentioned, this process may be repeated one or more times to provide sufficient washing at different steps of the plurality of assays.

In additional embodiments, the air source may also be one or more containers 38. Specifically, one or more containers 38 may comprise a volume of air that may be driven through the plurality of channels to function as a wash agent. In one embodiment, one or more containers 38 may be manufactured to include a volume of air for a wash agent. In other embodiments, after release of one or more reagents stored within the container 38 during operation of the electrochemical detection system 10, at least some containers 38 may at least partially fill with air or other gasses for use as a wash agent. In other words, after release of the regent stored within the container 38, air may be drawn into at least some containers 38, which may be later mechanically actuated again to drive air through the plurality of channels.

When introducing elements of the present disclosure or the embodiments(s) thereof, the articles “a,” “an,” “the,” and “said” are intended to mean that there are one or more of the elements. The terms “comprising,” “including,” and “having” are intended to be inclusive and mean that there may be additional elements other than the listed elements.

### EXAMPLES

The following examples detail some manners in which one skilled in the art may employ some embodiments of the electrochemical detection system. The following examples are not intended to be limiting of the disclosure and the claims, but rather an illustrative discussion regarding some uses of the system.

### Example 1

### Assay Protocol—Electrochemical TSH—Typical Sandwich Immunoassay

The conjugate is first diluted at a ratio of 1:500 in thyroid stimulating hormone (TSH) conjugate buffer and the calibrant is diluted in a TSH sample diluent to provide concentrations of 100, 10, 1, 0.1 and 0.01 mIU/mL. The sample was added using a volume of 150 μL, and a flow rate of 1 μL per second. In one embodiment, the assay protocol may require that 150 μL conjugate be added at a flow rate of 1 μL per second followed by an air wash at a flow rate of 3 μL per second for at least 10 seconds. Finally, 200 μL substrate was added at a flow rate of 3 μL per second. For example, SigmaFAST may be used as the substrate in a concentration of one set of SigmaFAST tablets for every 50 mL MilliQ water. The following flow times may be used: TSH sample at 2.5 minutes, conjugate at 2.5 minutes, air wash at 2.25 minutes, substrate at 1.25 minutes, and read time at 1 minute and 40 seconds. As such, the assay protocol may be performed in less than 10 minutes.

The sensors 28 are read using an applied voltage of −115 mV for 10 seconds and allowing an open circuit potential (OCP) for 90 seconds. The mV reading at the end of the 90-second OCP was taken as the final value.

### Example 2

### Assay Protocol for Electrochemical Free T4—Typical Competitive Immunoassay

The conjugate was diluted 1:5000 in Stabilzyme® horseradish peroxidase (HRP) and the free thyroxine (FT4) antibody diluted in a phosphate buffered saline (PBS) to provide a final concentration of 1.0 μg/mL. A sample having a T4 antibody in a ratio of 25 μL, antibody to 100 μL sample is provided to a flow cells followed by the air wash and a substrate. For example, the substrate may be provided at a concentration of one set of SigmaFAST tablets added for every 50 mL of MilliQ water.

In one embodiment, the sample with the antibodies may have a volume of 150 μL and a flow rate of 1 μL, per second when positively displaced by the sample reservoir 46 to one or more of the flow cells 94, 96, and 98. Once the sample was displaced, 150 μL tracer was provided at a flow rate of 1 μL per second followed by an air wash at a flow rate of 3 μL per second. Finally, 200 μL of substrate was provided at a flow rate of 3 μL per second. The following flow times may be used: Free T4 sample at 2.5 minutes, conjugate at 2.5 minutes, wash buffer at 2.25 minutes, substrate at 1.25 minutes, and read time at 1 minute and 40 seconds. As such, the assay protocol may be performed in less than 10 minutes.

The sensors 28 are read using an applied voltage of −115 mV for 10 seconds and allowing an open circuit potential (OCP) for 5 seconds, applying −115 mV for 8 seconds, allowing OCP for 8 seconds, re-applying −115 mV for 8 seconds, and then allowing an OCP for 90 seconds. The mV reading at the end of the 90-second OCP is taken as the final value by the software component 19.

It should be understood from the foregoing that, while particular embodiments have been illustrated and described, various modifications may be made thereto without departing from the spirit and scope of the disclosure as will be apparent to those skilled in the art. Such changes and modifications are within the scope and teachings of this disclosure as defined in the claims appended hereto.

1. A platform for performing a plurality of assays, comprising:
a support structure including a plurality of channels in selective fluid flow communication with at least one flow cell;
a plurality of sensors operatively associated with the at least one flow cell, the plurality of sensors being configured to detect a reaction during the performance of the plurality of assays; and
wherein at least some plurality of channels is in selective fluid flow communication with an air source, and further wherein the plurality of in selective fluid flow communication with the air source are configured to guide a volume of the air into the at least one flow cell during performance of the plurality of assays.

2. The platform of claim 1, wherein the volume of air is used to wash the plurality of sensors during the performance of the plurality of assays.

3. The platform of claim 1, wherein the volume of air exhibits a laminar flow through the at least one flow cell.

4. The platform of claim 1, further comprising a container pack including a plurality of containers for storing at least one fluid reagent, wherein the plurality of containers is at least partially engaged to the support structure.

5. The platform of claim 4, wherein the plurality of containers includes a means for the controlled release of the at least one fluid reagent when a force is applied to one or more of the plurality of containers.

6. The platform of claim 4, wherein at least some plurality of containers comprises air.

7. The platform of claim 6, wherein the plurality of containers that comprise air is in selective fluid flow communication with the at least one flow cell.

8. A cartridge for performing a plurality of assay protocols, comprising:
a container pack including a plurality of containers for storing at least one fluid reagent, at least a portion of the plurality of container comprising air;
a fluidic pathway engaged to the plurality of containers, the fluidic pathway including a plurality of channels in selective fluid flow communication with a plurality of flow cells through an arrangement of valves such that each plurality of flow cells is isolated from the other flow cells during the performance of a plurality of assay protocols; and
wherein at least some plurality of channels are in selective fluid flow communication with the plurality of containers comprising air for delivering a volume of the air to the plurality of flow cells during the performance of the plurality of assay protocols.

9. The cartridge of claim 8, further comprising a plurality of sensors operatively associated with a respective flow cell for detecting a reaction during the performance of the plurality of assay protocols.

10. The cartridge of claim 9, wherein the volume of air is used to wash the plurality of sensors during the performance of the plurality of assay protocols.

11. The cartridge of claim 8, wherein the volume of air exhibits a laminar flow through the plurality of flow cells.

12. The cartridge of claim 8, wherein the air stored within the plurality of containers is substantially free from contaminants.

13. The cartridge of claim 8, wherein the volume of air functions as a wash for the plurality of flow cells during the performance of the plurality of assay protocols.

14. The cartridge of claim 13, wherein the plurality of flow cells are washed only with air.

15. The cartridge of claim 8, wherein the plurality of flow cells are washed multiple times with multiple volumes of air during the performance of the plurality of assay protocols.

16. A method for manufacturing a cartridge configured for performing a plurality of assay protocols, the method comprising:
providing a container pack that includes a plurality of containers for storing at least one fluid reagent, wherein at least a portion of the plurality of containers comprises air as a wash agent;
disposing a plurality of sensors within each of the plurality of flow cells for detecting a chemical reaction during a performance of a plurality of assay protocols; and
engaging the plurality of containers to a fluidic pathway, the fluidic pathway including a plurality of channels in selective fluid flow communication with a plurality of flow cells through an arrangement of valves such that each plurality of flow cells is isolated from the other flow cells during the performance of the plurality of assay protocols,
wherein at least a portion of the plurality of channels fluidly couples the plurality of flow cells with the plurality of containers that comprise the wash agent such that the wash agent is delivered to the plurality of flow cells during the performance of the plurality of assay protocols.

17. The method of claim 16, further including disposing a sample reservoir at least partially within the fluidic pathway.

18. The method of claim 16, further including fluidly coupling at least some plurality of channels to a local environment so that the plurality of channels fluidly coupled with the local environment are configured to guide a volume of air from the local environment into one or more of the plurality of flow cells during the performance of the plurality of assays.

19. A method for operating a platform for performing a plurality of assay protocols, the method comprising:
providing a support structure including a plurality of channels in selective fluid flow communication with a plurality of flow cells, wherein at least a portion of the plurality of channels fluidly couple the plurality of flow cells with a source of a volume of air;
circulating a non-air fluid through at least some plurality of channels so that at least a portion of the non-air fluid passes into the plurality of flow cells; and
circulating at least a portion of the volume of air through the plurality of channels and into the plurality of flow cells to displace at least a portion of the non-air fluid within the plurality of flow cells.

20. The method of claim 19, wherein the source of the volume of air is a reservoir.

21. The method of claim 19, further comprising engaging a plurality of containers to the support structure.

22. The method of claim 21, wherein at least a portion of the plurality of containers is in selective fluid flow communication with the plurality of channels and functions as the source of the volume of air.

23. The method of claim 19, wherein the circulation of the non-air fluid and the circulation of the volume of air through the plurality of flow cells is repeated at least once.

24. A platform for performing a plurality of assays, comprising:
a support structure including a plurality of channels in selective fluid flow communication with a plurality of flow cells, the support structure further comprising at least one aperture defined through a portion of the support structure;
a plurality of sensors operatively associated with the plurality of flow cells, the plurality of sensors being configured to detect a reaction during the performance of the plurality of assays;
an actuating device being at least partially supported by the support structure and configured to enable selective fluid flow communication between the aperture defined through the side wall of the support structure and at least one of the plurality of channels; and
wherein the plurality of channels in selective fluid flow communication with the aperture are configured to guide a volume of air into the plurality of flow cells when the actuating device is activated.

25. The platform of claim 24, wherein the volume of air is used to wash the plurality of sensors during the performance of the plurality of assays.

26. The platform of claim 24, wherein the volume of air exhibits a laminar flow through the at least one flow cell.

27. The platform of claim 24, further comprising a plurality of containers for storing at least one fluid reagent, wherein the plurality of containers is at least partially engaged to the support structure.

28. The platform of claim 24, wherein the actuating device comprises a solenoid.

29. A method for assembling a platform for performing a plurality of assays, the method comprising:
providing a support structure including a plurality of channels in selective fluid flow communication with a plurality of flow cells;
disposing a plurality of sensors within each of the plurality of flow cells;
disposing an aperture at least partially through a portion of the support structure; and
positioning a solenoid immediately adjacent to the aperture such that when the solenoid is activated, the aperture comes in fluid flow communication with at least some of the plurality of channels, and a volume of air passes through the aperture and into the plurality of channels.

30. The method of claim 29, wherein the volume of air is used to wash the plurality of sensors during the performance of the plurality of assays.

31. The method of claim 29, wherein the volume of air exhibits a laminar flow through the at least one flow cell.

32. The method of claim 29, further comprising engaging a container pack to the support structure.

33. The method of claim 32, wherein the plurality of containers stores at least one fluid reagent.

34. A method for performing a plurality of assays, the method comprising:
providing a support structure including a plurality of channels in selective fluid flow communication with a plurality of flow cells;
disposing a plurality of sensors within each plurality of flow cells;
disposing an aperture at least partially through a portion of the support structure;
positioning a solenoid immediately adjacent to the aperture such that, when the solenoid is activated, the aperture comes in fluid flow communication with at least some of the plurality of channels, and a volume of air passes through the aperture and into the plurality of channels;
circulating a fluid through at least some of the plurality of channels so that at least a portion of the fluid passes into the plurality of flow cells and contacts the plurality of sensors;
activating the solenoid; and
circulating at least a portion of the volume of air through the plurality of channels and into the plurality of flow cells to displace at least a portion of the fluid within the plurality of flow cells.

35. A method for performing an assay, the method comprising:
circulating a sample through at least one flow cell, the at least one flow cell comprising a plurality of sensors;
incubating the sample within the at least one flow cell so that the sample contacts the plurality of sensors; and
circulating a volume of air through the at least one flow cell to wash the sample from the at least one flow cell and the plurality of sensors, wherein the volume of air is the only substance used to wash the at least one flow cell and the plurality of sensors.
